(19) United States
(12) Patent Application Publication
(10) Pub. No.: US 2010/0308145 A1
(43) Pub. Date: Dec. 9, 2010

(54) AUTOMATIC WASTE TREATMENT PROCESS

(75) Inventors: Olivier Doyen, Nanterre (FR); Pierre Casabonnet, Paris (FR); Jacques Meheut, Erquy (FR)

Correspondence Address: Seyfarth Shaw LLP, Two Seaport Lane, Suite 300, Boston, MA, 02210, US

(73) Assignee: VEOLIA PROPRETE, Nanterre (FR)

(21) Appl. No.: 12/738,990

(22) PCT Filed: Nov. 12, 2008
(86) PCT No.: PCT/FR2008/052033

§ 371 Date: Jul. 2, 2010

(30) Foreign Application Priority Data
Nov. 13, 2007 (FR) 0758977

(51) Int. Cl. B02B 5/02; G06F 17/30

(52) U.S. Cl. 241/101.2; 707/769; 707/802; 707/E17.014; 707/E17.044

(57) ABSTRACT

The invention relates to an automatic waste treatment process, and corresponding device, said process comprising the steps consisting in delivering a number of individual waste items conveying at least one individual waste item and analyzing said individual waste item. According to the invention, the step of analyzing the individual waste item includes a step consisting in determining the biogenic carbon content of the individual waste item.

### RELATED CASE INFORMATION

This application claims benefit of PCT Application No. PCT/FR08/052,033 filed Nov. 12, 2008 which claims benefit from French Application No. 0758977 filed Nov. 13, 2007.

### FIELD OF THE INVENTION

The present invention relates to the field of waste treatment, particularly solid waste, preferably organic, for example, household waste or trivial industrial type waste such as paper, cardboard, wood, plastic, etc.

### BACKGROUND OF THE INVENTION

According to a first object, the invention more specifically relates to an automatic waste treatment process, comprising the steps of delivering a number of individual waste items, conveying at least one individual waste item, and, analyzing the individual waste item.

Such a process is known by one skilled in the art, particularly by the example given through prior art document WO 2005/028128, wherein, waste is conveyed towards analyzing means comprising a hyperspectral sensor, coupled to a camera and possibly to other types of sensors, specifically, a metal detector.

The analyzing means make it possible to determine the nature of the waste for sorting purposes.

Meanwhile, in a context of waste valorization and environmental protection, the solution proposed by the prior art proves to be insufficient.

The object of the present invention is to remedy to these drawbacks by providing a solution for optimizing the treatment of waste, specifically in a context of renewable energy management.

With this objective in view, the process according to the invention, which still further conforms to the aforementioned preamble, is substantially characterized in that it further comprises a step of determining the biogenic carbon content of an individual waste item.

In fact, in a general context of depletion of fossil energy, the interest in non-fossil energy, called renewable energy, is set on at least three axes: raw material economy, minimal impact on the environment, particularly in terms of greenhouse gas emissions and more specifically of CO2, and economic valorization of (waste) products which were until now considered to be non recoverable.

### SUMMARY OF THE INVENTION

Although, trivial industrial or household waste are widely composed of combustible fraction which for some (paper, cardboard, wood, . . . ) are of biogenic origin, i.e., renewable, thus, neutral in terms of carbon balance with respect to greenhouse gases. On the other hand, for others, their composition is substantially based on organic material of fossil origin, specifically plastic.

Thanks to the invention, the value in use of a solid combustible derived from waste, not only according to its energy characteristics (calorific value, ash content . . . ) but also according to the origin of the carbon they contain may be established.

According to another of its objects, the invention relates to a waste treatment device, able to implement the process according to the invention, comprising means for conveying at least one individual waste item, and means for analyzing the individual waste item.

According to the invention, the device is substantially characterized in that it further comprises means for determining the biogenic carbon content of the individual waste item.

The invention makes it possible to continuously monitor the characteristics of a solid combustible made from waste, with a real time access to these data.

The whole treatment described by the invention may be carried out online, on an industrial site. Thus, it can be integrated in a regulation, instrumentation and control system of a solid combustible manufacturing unit made from waste so as to ensure the compliance to predefined characteristics for the production achieved.

The invention described for the specific case of its application to the elaboration of solid combustible made from waste, may also be used for other applications such as those encountered by mining industries, cereal manufactures, waste management.

Preferably after calibration, requiring only measurements carried out remotely from the waste using optical measures, the invention is of an acceptable operating cost.

### BRIEF DESCRIPTION OF THE DRAWINGS

Other characteristics and advantages of the present invention will become more apparent from the following description by way of non limitative example with reference to the accompanying drawings in which:

FIG. 1 illustrates an embodiment of the device according to the invention, and

FIG. 2 illustrates an embodiment of the process according to the invention.

### DETAILED DESCRIPTION OF THE INVENTION

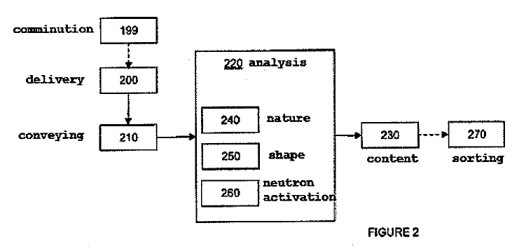

With reference to FIG. 2, a step of the process according to the invention consists in delivering 200 a number of individual waste items 1.

By individual waste, is meant a waste as such or a fragment thereof when the process according to the invention further performs at least a preliminary step 199 of communition of individual waste items.

According to the invention, the individual waste items 1 may be either of the same nature, or heterogeneous, i.e., of different nature, from various sources of raw material.

In the process of making solid combustible elaborated from waste, one or more steps of communition make it possible to on the one hand, free the different material making up certain complex waste, and on the other hand, to reduce the granulometry of the waste.

The individual waste items 1 are then conveyed 210 by conveying means 2, whereon they are placed, towards unitary waste item analyzing means for an analyzing step 220. The analyzing means particularly comprise electromagnetic analyzing means 3.

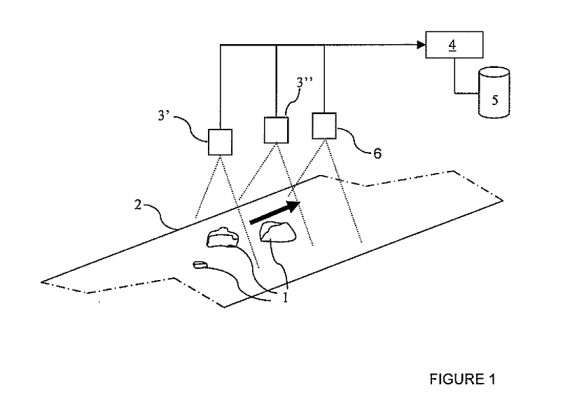

The conveying means comprise for example a conveyor 2, moving in translation, illustrated by the arrow (FIG. 1), preferably at constant speed.

According to the invention, the distribution of individual waste items 1 on the conveying means may be random.

The electromagnetic analyzing means 3 may be of different types, possibly multiple, as described subsequently, and are preferably configured to analyze the waste individually, individual waste item by individual waste item.

For example, a type 3′ of these electromagnetic analyzing means 3 is such that they are configured in order to implement a step 240 of determining the nature of said individual waste item.

Another type 3″ of these electromagnetic analyzing means is such that they are configured to be able to implement a step 250 of analyzing the shape of the individual waste item.

The step of determining the nature 240 of the waste makes it possible to determine the composing matter of the waste, i.e., its main constituent (paper, wood, cardboard, plastic, type of plastic, etc.).

In an embodiment, the step of determining the nature 240 of the waste is implemented at least by electromagnetic means 3′.

To this end, the nature of the individual waste item 1 is determined for example by optical means 3′ configured to carry out a spectral analysis of the light reflected by said individual waste item when it is subjected to an adapted and sufficiently intense lighting. This spectral analysis is classically employed in automatic sorting machines. Preferably, the studied spectrum is that emitted in the Near Infra-Red.

Thus, the step of determining the nature 240 of the waste makes it possible to determine if the individual waste item is made of paper, wood, plastic, etc.

Advantageously, the process according to the invention further comprises a step consisting in analyzing 250 the shape of the individual waste item.

To this end, in an embodiment, optical means 3″ preferably working in the visible domain, make an image, preferably a top view, of the individual waste item.

The contour in vertical projection of an individual waste item 1 is accessible for example via a digital camera as illustrated for example in application WO 2005/028128, or by an adhoc treatment of the signal used for the above-mentioned spectral analysis.

Preferably, the optical means 3′ and/or 3″ are designed such as to have a field of view encompassing the entire width of conveyor 2, and configured to be able to identify and analyze independently from one another the various individual waste items 1 possibly present in their field of view.

The shape image of each of the individual waste items 1 is processed by computation means, in this particular case, a computer 4 which particularly determines its contour, surface and the aspect ratio (length/width ratio of the smallest rectangle in which the contour of said individual waste item 1 can be inscribed).

According to the invention, the process further comprises a step 230 of determining the biogenic carbon content of the individual waste item.

The determination of the biogenic carbon content of the individual waste item may be achieved thanks to the analyzing step 220. It is implemented by measurement or estimation, through analyzing and computation means described hereinafter.

For example, in an embodiment, the determination of the biogenic carbon content of the individual waste item is implemented through estimation.

Depending on the determined nature 240 of the individual waste item and the shape analysis 250 of the individual waste item, the biogenic carbon content of the individual waste item is determined 230 by comparison to reference values of a reference database 5.

The reference database 5 particularly enables to associate to each nature or matter of the individual waste item, the physico-chemical characteristics specific to this nature, i.e., without this list being limitative, density, total biogenic and carbon content, calorific value, ash content, etc.

Advantageously, the reference database 5 stores a reference model comprising, for each waste nature, the mass and/or the biogenic carbon content of said waste for a given surface (aspect ratio).

The computer 4, receiving the data of the nature of the individual waste item, and its surface or its aspect ratio (the thickness of said waste being known or approximated), interrogates the reference database 5 and receives in return the specific characteristics of the corresponding matter/nature. It thus affects these characteristics and the biogenic carbon content coefficient/surface or aspect ratio to apply to said individual waste item in order to derive the biogenic carbon content (i.e., mass) of said individual waste item 1, thus advantageously making it possible to avoid the step of measuring the mass of each individual waste item.

The individual biogenic carbon content of an individual waste item may be stored and added up so as to compute the total mass of biogenic carbon of a batch of individual waste items.

Furthermore, according to the communition technologies used and the material composing the comminuted objects, it is also possible to relate to each fragment, i.e., to each individual waste item, a statistical distribution, obtained through experiment, of the masses of fragments of the same matter and of the same dimensional appearance (comparable surface and length/width ratio of the minimum bounding rectangle)

This statistical distribution possibly stored in the reference database 5, or in another database, makes it possible to estimate for example the thickness of said waste, and also the mass (or the biogenic carbon content) of each individual waste item based on the knowledge of its nature (the matter it is composed of) and of the vertical projection of its contour on a horizontal plane. It also makes it possible to assess the uncertainty about this mass determination from distribution characteristics (variance, standard deviation).

The matching of each individual waste item with the determined mass as indicated above and of its physico-chemical characteristics makes it possible to provide it with properties such as: calorific value, total mass of organic and biogenic carbon contained, ash content, etc.

The database 5 is advantageously updated by experiment, and possibly dynamically.

In another embodiment, the determination of the biogenic carbon content of the individual waste item is carried out by measurement.

To this end, the process according to the invention comprises a neutron activation step 260, implemented on each individual waste item 1 by neutron activation means 6.

Preferably, the neutron activation step is implemented on the totality of the volume of the individual waste item 1.

Alternatively, the neutron activation step can be implemented on a portion, a sample, of the volume of the individual waste item 1. In this case, it is desirable to link the result of biogenic carbon content obtained from the statistical distribution or from the surface measure mentioned above. That is to say, that the process may comprise steps of computing the ratio between the size of the sample and that of the individual waste item, for example by the ratio of the respective aspect ratios, and according to said ratio and of the value obtained for said sample, compute/provide said individual waste item with the value of its biogenic carbon content.

In an embodiment, the process according to the invention further comprises a step 270 of sorting the individual waste items.

The sorting may be carried out according to the nature of the biogenic content of the individual waste items 1. For example, the selection of all the individual waste items whereof the biogenic carbon content is higher or lower than a predetermined threshold may be carried out.

The invention is not limited to the previously described embodiments.

For example, the invention may also be implemented with the view of qualifying and monitoring a batch of individual waste items, for example, when the individual waste items originate from a selective sorting.

It may also play an active role in the production process, such as to selectively orient the tonnages produced towards different storages each corresponding to a defined quality or a biogenic carbon content. In this case the qualification is preferably operated on relatively low quantities (a few hundreds of kilos to a few tons for example) directed towards an intermediary hopper, then consigned after qualification towards the appropriate storage.

What is claimed is:

1. An automatic waste treatment process comprising steps of:
delivering a number of individual waste items, including at least a preliminary step of comminuting the waste;
conveying at least one individual waste item; and
determining the biogenic carbon content of the individual waste item.

2. The treatment process according to claim 1, wherein said determining the biogenic carbon content includes:
determining the main constituents of the individual waste item, and
analyzing the shape of the individual waste item.

3. The treatment process according to claim 2, comprising a step of:
depending on said determined main constituents and the analysis of the shape of the individual waste item, determining the biogenic carbon content of the individual waste item through comparison to reference values from a reference database.

4. The treatment process according to claim 3, further comprising:
performing neutron activation on said individual waste items.

5. The treatment process according to claim 4, further comprising a step of sorting the individual waste items.

6. A waste treatment device comprising:
means for conveying at least one individual waste item, obtained by waste communition means;
means for electromagnetically analyzing said individual waste item on said means for conveying; and
means for determining the biogenic carbon content of the individual waste item in response to said electromagnetic analyzing means wherein:
said electromagnetic analyzing means include means for analyzing the shape of said waste.

7. The treatment device according to claim 6, wherein said electromagnetic analyzing means comprise means for determining the main constituents of the individual waste item.

8. The treatment device according to claim 7, comprising means for computing the surface and/or the aspect ratio of said individual waste item, and
a database storing a reference model comprising, the biogenic carbon content of said waste for a surface and/or a given aspect ratio, and for the main constituents wherein:
the computation means are in communication with the database.

9. A device according to claim 6, comprising neutron activation means configured to perform neutron activation on said waste items.
